(19) United States
(12) Patent Application Publication
(10) Pub. No.: US 2015/0328646 A1
(43) Pub. Date: Nov. 19, 2015

(54) Shower Head Attachment

(71) Applicant: Linda Granger, Beaumont, CA (US)

(72) Inventor: Linda Granger, Beaumont, CA (US)

(21) Appl. No.: 14/538,035

(22) Filed: Nov. 11, 2014

Related U.S. Application Data
(60) Provisional application No. 61/992,486, filed on May 13, 2014.

(51) Int. Cl. B05B 1/18

(52) U.S. Cl. CPC B05B 1/185

(57) ABSTRACT

A shower head attachment for allowing a shower head to be easily removed from a shower fixture for cleaning. The shower head attachment includes a first tubular section that can be secured to a shower head, and a second tubular section that can be secured to a shower fixture. Preferably, the first and second tubular sections are secured to the shower head and shower fixture, respectively, by threaded engagement. The first and second tubular sections can be removably secured together by a snap connection so that the first and second tubular sections are easily separable. In this way, the user can easily remove the shower head by separating the first and second tubular sections when the user desires to clean the shower head.

### CROSS REFERENCE TO RELATED APPLICATION

This application claims the benefit of U.S. Provisional Application No. 61/992,486 filed on May 13, 2014. The above identified patent application is herein incorporated by reference in its entirety to provide continuity of disclosure.

### BACKGROUND OF THE INVENTION

1. Field of the Invention

The present invention relates to shower head attachments. More specifically, the present invention provides a tubular device to be positioned between a shower head and shower fixture that provides a means for easily separating the shower head from the shower fixture for cleaning.

Shower heads must be cleaned periodically in order to remove calcium and limestone build-up, among other types of hard water stains. These deposits can adversely affect the operation of the shower head, and may reduce water flow and water pressure through the shower head. Further, the deposits may detract from the appearance of both the shower head and shower fixture.

In order to clean the shower head, the shower head must typically be removed from the shower fixture. However, separating the shower head from the shower fixture can be a difficult and laborious task. If the shower head has not been removed for some time, the shower head may be particularly difficult to remove from the shower fixture. Generally, a wrench must be used to loosen the connection between the shower head and fixture. When using the wrench, care must be taken to avoid scratching or damaging the shower head or fixture with the teeth of the wrench. Thus, a device that facilitates removal of a shower head from a shower fixture is desired.

The present invention provides a shower head attachment to be disposed between a shower head and shower fixture. The shower head attachment includes a first and second tubular section, each having a hollow interior through which water can flow. The first tubular section is removably securable to a shower head, and the second tubular section is removably securable to a shower fixture. Preferably, the first and second tubular sections are secured to the shower head and the shower fixture by threaded engagement, respectively. Further, the first and second tubular sections can be removably engaged to one another by a snap connection. The connection between the first and second tubular sections is substantially water-tight so that water will not escape through the connection. The snap connection can be easily removed as desired by the user so that the user can clean the shower head and fixture.

2. Description of the Prior Art

Devices have been disclosed in the prior art that relate to shower head attachments. These include devices that have been patented and published in patent application publications. These devices generally relate to shower head attachments having quick-disconnect fittings. The following is a list of devices deemed most relevant to the present disclosure, which are herein described for the purposes of highlighting and differentiating the unique aspects of the present invention, and further highlighting the drawbacks existing in the prior art.

One such device, U.S. Published Patent Application Number 2006/0283336 to Eveleigh et al. discloses a shower head that can be quickly disconnected. The shower head has a housing that can receive a quick disconnect fitting connected to a hose. The hose can be easily disconnected from the shower head housing. Thus, while Eveleigh et al. discloses a shower head that can be easily disconnected, Eveleigh et al. fails to disclose a shower head attachment having a pair of separable tubular sections connectable to a shower head and shower fixture.

U.S. Published Patent Application Number 2004/0217196 to Yurek, Jr. et al discloses a device for converting a shower head to a handheld shower sprayer. The device includes a set of in-line couplers to quickly disconnect a showerhead from a water supply and connect a flexible tubing thereto. The couplers include a threaded female coupler that is fastened to the water supply pipe's threaded end, and a male coupler that is fastened to the showerhead threaded end. The shower head can be connected by the male coupler to the female coupler at the water supply pipe. Thus, Yurek, Jr. et al discloses a quickly detachable shower head having male and female couplers. Yurek, Jr. et al fails to disclose a shower head attachment wherein the shower head can be removably secured to a shower fixture via a snap connection to facilitate removal thereof.

U.S. Pat. No. 5,167,431 to Maifredi discloses an insert for connecting a flexible tube to a shower head. The device includes an axial pipe having keying and sealed truing structure in a seat of the shower head. The device includes an elastic tab that can clip into a hole formed at the level of the seat. The keying structure prevents rotation of the insert. Thus, Maifredi discloses an insert for connecting a tube to a shower head and fails to disclose a device that facilitates removal of a shower head from a shower fixture.

U.S. Pat. No. 5,926,868 to Bjerke discloses a bathtub shower system having a fitting that can be threadedly connected to a faucet. The fitting includes a backflow preventer assembly having a quick disconnect so that it can be easily connected or disconnected. The backflow preventer assembly is coupled to a shower head hose for use by an individual sitting in a bathtub. Thus, Bjerke does not disclose a device that allows a user to easily remove a shower head from a shower fixture for cleaning.

Finally, U.S. Pat. No. 5,845,345 to Ko discloses a wall-mounted tap having a removable shower head spout. The tap includes a mount, a body, a valve mount, a vacuum breaker, a check valve, a pair of hot and cold water inlets, a water outlet, and a removable hand held shower head. Ko does not disclose a shower head attachment that allows a shower head to be easily removed from a shower fixture for cleaning.

These prior art devices have several known drawbacks. Devices in the prior art relate to shower head or faucet attachment devices. The devices include quick disconnect attachments for removing a shower head or other similar element. However, these devices do not describe a shower head attachment having a first section removably securable to a shower head, a second section removably securable to a shower fixture, wherein the first and second sections are removably securable to one another via a snap connection. The snap connection is water-tight and allows the shower head to be easily removed for cleaning as desired by the user.

In light of the devices disclosed in the prior art, it is submitted that the present invention substantially diverges in design elements from the prior art and consequently it is clear that there is a need in the art for an improvement to existing shower head attachment devices. In this regard the instant invention substantially fulfills these needs.

### SUMMARY OF THE INVENTION

In view of the foregoing disadvantages inherent in the known types of shower head attachments now present in the prior art, the present invention provides a new shower head attachment wherein the same can be utilized for providing convenience for the user when removing a shower head for cleaning.

It is therefore an object of the present invention to provide a new and improved shower head attachment device that has all of the advantages of the prior art and none of the disadvantages.

It is another object of the present invention to provide a shower head attachment device that allows a shower head to be easily removed from a shower fixture without the use of tools.

Another object of the present invention is to provide a shower head attachment device having a first section securable to a shower head, a second section securable to a shower fixture, wherein the first and second sections are securable to one another via a snap connection.

Yet another object of the present invention is to provide a shower head attachment that is easily installed and that can be used with any of a variety of shower heads and fixtures.

Another object of the present invention is to provide a shower head attachment that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a disassembled view of the shower head attachment of the present invention.

FIG. 2 shows a perspective view of the shower head attachment as positioned for connection.

FIG. 3 shows a perspective view of the shower head attachment as installed on a shower head.

FIG. 4 shows a perspective view of the connection between the first and second tubular sections of the shower head attachment.

### DETAILED DESCRIPTION OF THE INVENTION

Reference is made herein to the attached drawings. Like reference numerals are used throughout the drawings to depict like or similar elements of the shower head attachment. For the purposes of presenting a brief and clear description of the present invention, the preferred embodiment will be discussed as used for easily connecting and disconnecting a shower head for cleaning. The figures are intended for representative purposes only and should not be considered to be limiting in any respect.

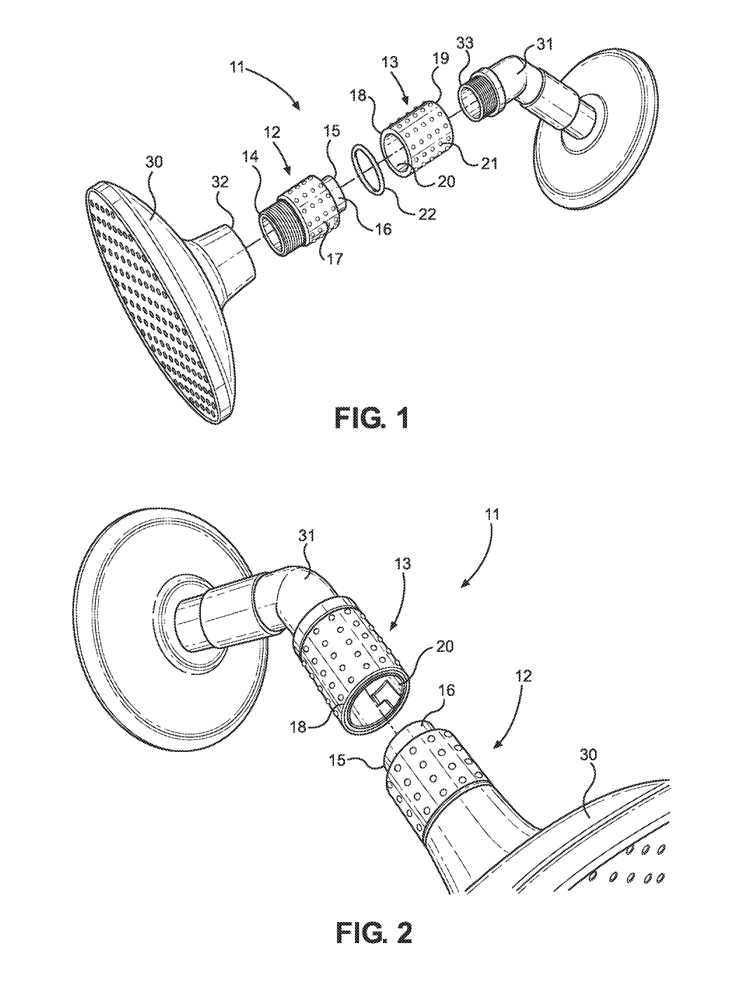

Referring now to FIG. 1, there is shown a disassembled view of the shower head attachment of the present invention. The shower head attachment 11 is adapted to be disposed between a shower head 30 and a shower fixture 31. Water can flow through the shower fixture 31, into the shower head attachment 11, and out through the shower head 30. The shower head attachment 11 comprises a first tubular section 12 and a second tubular section 13. Each tubular section 12, 13 is open at both ends thereof and includes a hollow interior volume. In this way, water or other liquid can flow through the hollow interior volume of the first and second tubular sections 12, 13.

The first tubular section 12 includes a first end 14 and a second end 15. The first end 14 includes a threaded exterior so as to engage with the threading on the interior the neck 32 of a conventional shower head 30. Thus, the shower head attachment 11 can be used with various types of shower heads 30 having threading thereon. The second end 15 includes a male fastener 16 adapted to engage with a female fastener on the second tubular section. The body 17 of the first tubular section 12 includes ridges or a textured surface so that the body 17 can be easily grasped by a user, even when the shower head attachment 11 is wet.

The second tubular section 13 includes a first end 18 and a second end 19. The first end 18 includes a female fastener 20 thereon adapted to receive the male fastener 16 of the first tubular section 12. The first end 18 includes an annular gasket 22 to help create a watertight seal between the first tubular section 12 and the second tubular section 13. The second end 19 includes threading thereon adapted to engage with the threaded end 33 of a shower fixture 31. The body 21 of the second tubular member 13 includes ridges or a textured surface to help the user to grasp the body 21 of the second tubular member 13.

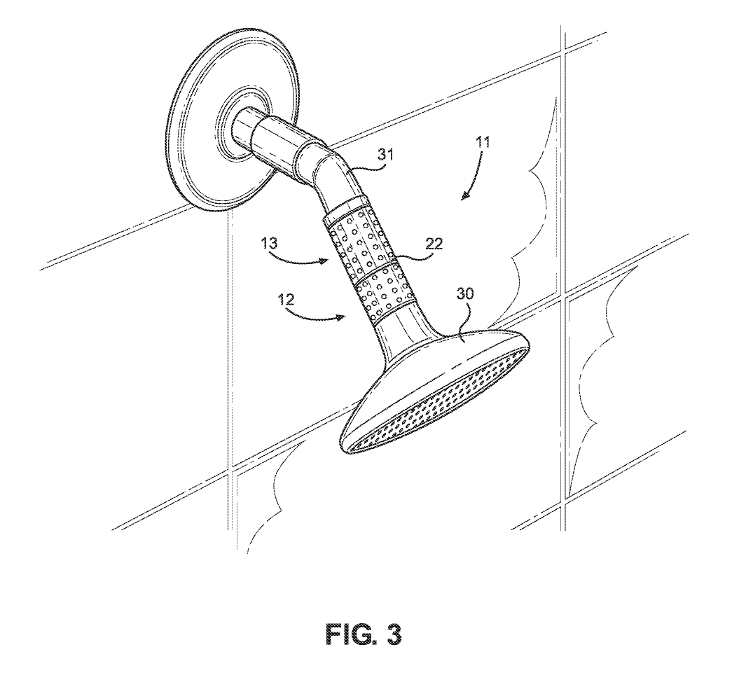

Referring now to FIGS. 2 and 3, there is shown a perspective view of the shower head attachment as positioned for connection and as connected. The first tubular member 12 can be removably secured to the neck of the shower head 30 by engaging the threading thereon. A watertight seal is created so as to prevent any leakage. Similarly, the second tubular member 13 is removably secured to the end of the shower fixture 31 by engaging the threading thereon. A watertight seal is created so as to prevent leakage.

The female fastener 20 on the first end 18 of the second tubular section 13 is adapted to receive the male fastener 16 on the second end 15 of the first tubular section 12. Preferably, the female fastener 20 and male fastener 16 engage with a snap connection or press fit connection. Thus, once the male fastener 16 is positioned within the female fastener 20, the snap connection can be engaged, securing the first and second tubular sections together. Similarly, the first tubular section 12 and shower head thereon can be removed from the second tubular section 13 by pulling the first tubular section 12 outward from the second tubular section 13.

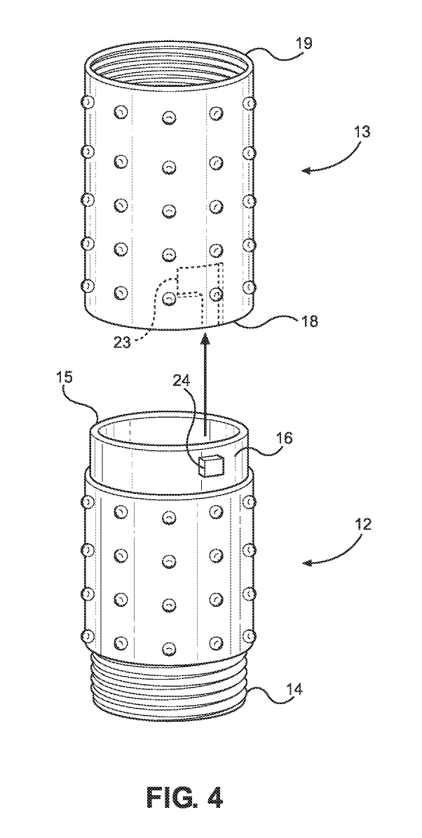

Referring now to FIG. 4, there is shown a perspective view of the connection between the first and second tubular sections of the shower head attachment. The first tubular section 12 can be removably secured to the second tubular section 13 via a snap connection or press fit connection. The male fastener 16 on the second end 15 of the first tubular section 12, includes a protrusion 24. The protrusion 24 is shown as having a square shape, but may be provided in alternate shapes. The protrusion 24 is adapted to be inserted into a channel 23 on the interior of the first end 18 of the second tubular member 13. The channel 23 is preferably L-shaped so that the protrusion 24 can be inserted therein, and then secured in position by twisting the first section 12 relative to the second section 13. By engaging the protrusion 24 with the channel 23, the first tubular section 12 is secured to the second tubular section 13 by a snap connection or press fit, creating a water-tight seal. A gasket may be disposed between the first and second tubular sections 12, 13 to help create a water-tight seal, or a gasket may be integrated onto the first end 18 of the second tubular member 13. Further, the first and second tubular sections 12, 13 can be easily separated as desired by removing the protrusion 24 from the channel 23 on the second tubular section 13.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A shower head attachment, comprising:
a first tubular section having a first end and a second end;
a second tubular section having a first end and a second end;
wherein said first end of said first tubular section is removably securable to a shower head;
wherein said second end of said second tubular section is removably securable to a shower fixture;
wherein said second end of said first tubular section is removably securable to said first end of said second tubular section via a snap connection.

2) The shower head attachment of claim 1, wherein said first end of said first tubular section includes threading thereon.

3) The shower head attachment of claim 1, wherein said second end of said second tubular section includes threading thereon.

4) The shower head attachment of claim 1, wherein a body of said first tubular section and a body of said second tubular section include a textured surface.

5) The shower head attachment of claim 1, wherein said second end of said first tubular section includes a male fastener, and wherein said first end of said second tubular section includes a female fastener adapted to receive said male fastener.

6) The shower head attachment of claim 1, wherein said first end of said second tubular section includes an annular gasket thereon adapted to create a watertight seal.

7) The shower head attachment of claim 1, wherein said first tubular section comprises a protrusion thereon adapted to be inserted into a channel on said second tubular section so as to further secure said first tubular section and said second tubular section.

8) The shower head attachment of claim 7, wherein said channel on said second tubular second comprises an L-shape.
